(19) United States
(12) Patent Application Publication
(10) Pub. No.: US 2026/0065862 A1
(43) Pub. Date: Mar. 5, 2026

(54) PIXEL DRIVING CIRCUIT AND DISPLAY DEVICE

(71) Applicant: HKC CORPORATION LIMITED, Shenzhen (CN)

(72) Inventors: Zhiwei YE, Shenzhen (CN); Chen CHEN, Shenzhen (CN); Xiufeng ZHOU, Shenzhen (CN); Lidan YE, Shenzhen (CN)

(21) Appl. No.: 19/308,744

(22) Filed: Aug. 25, 2025

(30) Foreign Application Priority Data
Aug. 30, 2024 (CN) 202411219583.7

(51) Int. Cl. G09G 3/3233

(52) U.S. Cl. CPC G09G 3/3233; G09G 2300/0465; G09G 2300/0819; G09G 2300/0842; G09G 2300/0861; G09G 2310/08; G09G 2320/0233

(57) ABSTRACT

A pixel driving circuit and a display device are provided. The pixel driving circuit includes a data input circuit, a reset circuit, an energy storage circuit, a light-emitting control circuit, a compensation circuit, a first switch-circuit, a second switch-circuit, and a third switch-circuit. The data input circuit is electrically connected to a first end of the light-emitting control circuit and a first control end of the light-emitting control circuit. An output end of the reset circuit is electrically connected to a second control end of the light-emitting control circuit. A second end of the light-emitting control circuit is electrically connected to the first switch-circuit. The first end of the light-emitting control circuit is configured to be electrically connected to an anode of a light-emitting device through the second switch-circuit. An output end of the compensation circuit is configured to be electrically connected to the anode of the light-emitting device.

### CROSS-REFERENCE TO RELATED APPLICATIONS

This application claims priority under 35 U.S.C. § 119(a) to Chinese Patent Application No. 202411219583.7, filed Aug. 30, 2024, the entire disclosure of which is incorporated herein by reference.

### TECHNICAL FIELD

This disclosure relates to the field of display technology, and in particular, to a pixel driving circuit and a display device.

### BACKGROUND

For display panels, accuracy and uniformity of image display are usually improved by internal driving-circuit compensation. For example, an internal compensation circuit 6T1C can be used. However, a conventional internal compensation circuit needs multiple groups of driving timings, including two groups of scanning signals and two groups of enable signals. As a result, a boundary value of a panel becomes larger, so that the panel cannot be adapted to requirements of a narrow bezel.

### SUMMARY

In a first aspect, a pixel driving circuit is provided in implementations of the present disclosure. The pixel driving circuit includes a data input circuit, a reset circuit, an energy storage circuit, a light-emitting control circuit, a compensation circuit, and a first switch-circuit, a second switch-circuit, and a third switch-circuit. The data input circuit is electrically connected to a first end of the light-emitting control circuit and a first control end of the light-emitting control circuit, and is configured to output a data signal to the first control end of the light-emitting control circuit according to a first scanning signal in a data-writing phase. An output end of the reset circuit is electrically connected to a second control end of the light-emitting control circuit, and the reset circuit is configured to output a reference voltage to the second control end of the light-emitting control circuit according to a second scanning signal in a reset phase. A second end of the light-emitting control circuit is electrically connected to the first switch-circuit. The first end of the light-emitting control circuit is configured to be electrically connected to an anode of a light-emitting device through the second switch-circuit. The light-emitting control circuit is configured to output a driving current to the light-emitting device in a light-emitting phase. An output end of the compensation circuit is configured to be electrically connected to the anode of the light-emitting device. One end of the energy storage circuit is electrically connected to the output end of the reset circuit, and the other end of the energy storage circuit is electrically connected to the output end of the compensation circuit. One end of the third switch-circuit is electrically connected to the output end of the reset circuit, and the other end of the third switch-circuit is electrically connected to the second end of the light-emitting control circuit. The compensation circuit and the third switch-circuit are configured to be turned on according to the first scanning signal in the data-writing phase. The first switch-circuit and the second switch-circuit are configured to be turned on according to an enable signal in the light-emitting phase.

In a second aspect, a display device is provided in implementations of the present disclosure. The display device includes multiple light-emitting devices distributed in an array and a pixel driving circuit. The pixel driving circuit is configured to drive the multiple light-emitting devices to operate. The pixel driving circuit includes a data input circuit, a reset circuit, an energy storage circuit, a light-emitting control circuit, a compensation circuit, and a first switch-circuit, a second switch-circuit, and a third switch-circuit. The data input circuit is electrically connected to a first end of the light-emitting control circuit and a first control end of the light-emitting control circuit, and is configured to output a data signal to the first control end of the light-emitting control circuit according to a first scanning signal in a data-writing phase. An output end of the reset circuit is electrically connected to a second control end of the light-emitting control circuit, and the reset circuit is configured to output a reference voltage to the second control end of the light-emitting control circuit according to a second scanning signal in a reset phase. A second end of the light-emitting control circuit is electrically connected to the first switch-circuit. The first end of the light-emitting control circuit is electrically connected to an anode of the multiple light-emitting devices through the second switch-circuit. The light-emitting control circuit is configured to output a driving current to each of the multiple light-emitting devices in a light-emitting phase. An output end of the compensation circuit is electrically connected to the anode of each of the multiple light-emitting devices. One end of the energy storage circuit is electrically connected to the output end of the reset circuit, and the other end of the energy storage circuit is electrically connected to the output end of the compensation circuit. One end of the third switch-circuit is electrically connected to the output end of the reset circuit, and the other end of the third switch-circuit is electrically connected to the second end of the light-emitting control circuit. The compensation circuit and the third switch-circuit are configured to be turned on according to the first scanning signal in the data-writing phase. The first switch-circuit and the second switch-circuit are configured to be turned on according to an enable signal in the light-emitting phase.

### BRIEF DESCRIPTION OF THE DRAWINGS

To more clearly describe implementations in the present disclosure or technical solutions in related art, the accompanying drawings that need to be used in description of implementations or the related art will be briefly introduced below. Apparently, the accompanying drawings in the following description are only some implementations in the present disclosure, and those of ordinary skill in the art may also obtain other accompanying drawings based on these accompanying drawings without creative effort.

FIG. 1 is a schematic block diagram of a pixel driving circuit provided in an embodiment of the present disclosure.

FIG. 2 is a circuit diagram of a pixel driving circuit provided in an embodiment of the present disclosure.

FIG. 3 is a timing diagram of a pixel driving circuit provided in an embodiment of the present disclosure.

### DETAILED DESCRIPTION

Technical solutions of implementations in the present disclosure will be described clearly and completely below with reference to accompanying drawings in implementations of the present disclosure. Apparently, implementations described herein are merely some implementations, rather than all implementations, of the present disclosure. Based on implementations of the present disclosure, all other implementations obtained by those of ordinary skill in the art without creative effort shall fall within the protection scope of the present disclosure.

It may be noted that when a component is referred to as “fixed to” another component, the component may be directly positioned on the other component or an intermediate component may exist therebetween. When a component is referred to as “connected to” another component, the component may be directly connected to the other component or an intermediate component may exist therebetween simultaneously.

Unless otherwise defined, all technical and scientific terms used in the present disclosure have the same meaning as commonly understood by those skilled in the art of the present disclosure. The terms used in the detailed description in the present disclosure are for the purpose of describing specific embodiments only and are not intended to limit the present disclosure. The term “and/or” in the present disclosure includes any and all combinations of one or more related listed items.

The following will describe in detail some implementations of the present disclosure with reference to the accompanying drawings. Various embodiments and features therein may be implemented in any combination with each other without conflict.

Active-matrix Organic Light Emitting Diodes (AMOLEDs) are regarded as one of the most promising display technologies in the industry due to their advantages such as self-luminescence, low power consumption, wide viewing angle, high color gamut, high contrast ratio, fast response, and the like. In the related art, the accuracy and uniformity of image display are usually improved by internal driving-circuit compensation. For example, an internal compensation circuit 6T1C can be used. However, a conventional internal compensation circuit needs multiple groups of driving timings, including scan1/scan2/EM1/EM2. As a result, a boundary value of a panel becomes larger, so that the panel cannot be adapted to requirements of a narrow bezel.

The present disclosure provides a pixel driving circuit and a display device that can narrow a boundary of a panel.

In a first aspect, a pixel driving circuit is provided in implementations of the present disclosure. The pixel driving circuit includes a data input circuit, a reset circuit, an energy storage circuit, a light-emitting control circuit, a compensation circuit, and a first switch-circuit, a second switch-circuit, and a third switch-circuit. The data input circuit is electrically connected to a first end of the light-emitting control circuit and a first control end of the light-emitting control circuit, and is configured to output a data signal to the first control end of the light-emitting control circuit according to a first scanning signal in a data-writing phase. An output end of the reset circuit is electrically connected to a second control end of the light-emitting control circuit, and the reset circuit is configured to output a reference voltage to the second control end of the light-emitting control circuit according to a second scanning signal in a reset phase. A second end of the light-emitting control circuit is electrically connected to the first switch-circuit. The first end of the light-emitting control circuit is configured to be electrically connected to an anode of a light-emitting device through the second switch-circuit. The light-emitting control circuit is configured to output a driving current to the light-emitting device in a light-emitting phase. An output end of the compensation circuit is configured to be electrically connected to the anode of the light-emitting device. One end of the energy storage circuit is electrically connected to the output end of the reset circuit, and the other end of the energy storage circuit is electrically connected to the output end of the compensation circuit. One end of the third switch-circuit is electrically connected to the output end of the reset circuit, and the other end of the third switch-circuit is electrically connected to the second end of the light-emitting control circuit. The compensation circuit and the third switch-circuit are configured to be turned on according to the first scanning signal in the data-writing phase. The first switch-circuit and the second switch-circuit are configured to be turned on according to an enable signal in the light-emitting phase.

According to the first aspect, in a possible implementation, the reset circuit includes a reset transistor. A first electrode of the reset transistor is electrically connected to the second control end of the light-emitting control circuit. The reset transistor is configured to receive a reference voltage through a second electrode of the reset transistor. The reset transistor is configured to receive the second scanning signal through a gate of the reset transistor.

According to the first aspect, in a possible implementation, the first scanning signal is a scanning signal at a present phase. The second scanning signal is a scanning signal at a previous phase.

According to the first aspect, in a possible implementation, in the reset phase, the first scanning signal is at a low potential, the second scanning signal is at a high potential, the enable signal is at a low potential, and the data signal is at a low potential.

According to the first aspect, in a possible implementation, in the data-writing phase, the first scanning signal is at a high potential, the second scanning signal is at a low potential, the enable signal is at a low potential, and the data signal is at a high potential.

According to the first aspect, in a possible implementation, in the light-emitting phase, the first scanning signal is at a low potential, the second scanning signal is at a low potential, the enable signal is at a high potential, and the data signal is at a low potential.

According to the first aspect, in a possible implementation, the data input circuit includes a writing transistor. The writing transistor is configured to receive the data signal through a first electrode of the writing transistor. A second electrode of the writing transistor is electrically connected to an output end of the light-emitting control circuit and the first control end of the light-emitting control circuit. The writing transistor is configured to receive the first scanning signal through a gate of the writing transistor.

According to the first aspect, in a possible implementation, the first switch-circuit includes a first transistor. The second switch-circuit includes a second transistor. The first transistor is configured to receive the enable signal through a gate of the first transistor. The second transistor is configured to receive the enable signal through a gate of the second transistor.

According to the first aspect, in a possible implementation, the third switch-circuit includes a third transistor. A first electrode of the third transistor is electrically connected to an input end of the light-emitting control circuit. A second electrode of the third transistor is electrically connected to the output end of the reset circuit. The third transistor is configured to receive the first scanning signal through a gate of the third transistor. The third transistor is an Indium Gallium Zinc Oxide (IGZO) transistor.

According to the first aspect, in a possible implementation, the compensation circuit includes a fourth transistor. The fourth transistor is configured to receive the first scanning signal through a gate of the fourth transistor. The fourth transistor is configured to receive the reference voltage through a first electrode of the fourth transistor. A second electrode of the fourth transistor is configured to be electrically connected to the anode of the light-emitting device.

In a second aspect, a display device is provided in implementations of the present disclosure. The display device includes multiple light-emitting devices distributed in an array and a pixel driving circuit. The pixel driving circuit is configured to drive the multiple light-emitting devices to operate. The pixel driving circuit includes a data input circuit, a reset circuit, an energy storage circuit, a light-emitting control circuit, a compensation circuit, and a first switch-circuit, a second switch-circuit, and a third switch-circuit. The data input circuit is electrically connected to a first end of the light-emitting control circuit and a first control end of the light-emitting control circuit, and is configured to output a data signal to the first control end of the light-emitting control circuit according to a first scanning signal in a data-writing phase. An output end of the reset circuit is electrically connected to a second control end of the light-emitting control circuit, and the reset circuit is configured to output a reference voltage to the second control end of the light-emitting control circuit according to a second scanning signal in a reset phase. A second end of the light-emitting control circuit is electrically connected to the first switch-circuit. The first end of the light-emitting control circuit is electrically connected to an anode of the multiple light-emitting devices through the second switch-circuit. The light-emitting control circuit is configured to output a driving current to each of the multiple light-emitting devices in a light-emitting phase. An output end of the compensation circuit is electrically connected to the anode of each of the multiple light-emitting devices. One end of the energy storage circuit is electrically connected to the output end of the reset circuit, and the other end of the energy storage circuit is electrically connected to the output end of the compensation circuit. One end of the third switch-circuit is electrically connected to the output end of the reset circuit, and the other end of the third switch-circuit is electrically connected to the second end of the light-emitting control circuit. The compensation circuit and the third switch-circuit are configured to be turned on according to the first scanning signal in the data-writing phase. The first switch-circuit and the second switch-circuit are configured to be turned on according to an enable signal in the light-emitting phase.

For the pixel driving circuit and the display device provided in the present disclosure, the second scanning signal controls on/off of the reset circuit, and on condition that the reset circuit is turned on, the reset circuit can output the reference voltage to the second control end of the light-emitting control circuit, thereby resetting of the light-emitting control circuit. The first scanning signal controls on/off of each of the data input circuit, the compensation circuit, the light-emitting control circuit, and the third switch-circuit, and on condition that each of the data input circuit, the compensation circuit, the light-emitting control circuit, and the third switch-circuit is turned on, the data signal is used for writing the data voltage into the energy storage circuit. The enable signal controls on/off of each of the first switch-circuit and the second switch-circuit, and on condition that each of the first switch-circuit and the second switch-circuit is turned on, the energy storage circuit can output the data voltage written in the previous phase to the second control end of the light-emitting control circuit, so that the light-emitting device emits light. Thus, the second scanning signal, the first scanning signal, and the enable signal are combined and corresponds to the reset phase, the data-writing phase, and the light-emitting phase in sequence. The number of driving lines is reduced, which facilitates reducing the width of the frame.

In the display device, light-emitting devices 200 are generally distributed in an array on a display panel. Each light-emitting device 200 is equipped with a corresponding pixel driving circuit 100 for driving the light-emitting device 200 to operate. Such a one-to-one correspondence ensures that each light-emitting device can be controlled independently and accurately, thereby realizing high-quality image display.

The pixel driving circuit 100 is a bridge for connecting the light-emitting device 200 and a control system of the display device. The pixel driving circuit 100 is responsible for receiving a signal from the control system and converting the signal into a driving current or a driving voltage required for the light-emitting device 200. By means of accurate timing control and an internal compensation mechanism, the pixel driving circuit 100 can ensure stable and uniform brightness output by the light-emitting device 200 in a light-emitting phase, thereby improving uniformity and color accuracy of an image.

A display panel 1000, as a core component of the display device, has an extremely wide application range. The display panel 1000 can be used not only in traditional consumer electronics products, such as a mobile phone, a television, a tablet computer, etc., but can also be extended to more fields, such as a wireless apparatus, a Personal Data Assistant (PDA), a handheld or portable computer, a Global Positioning System (GPS) receiver/navigator, a camera, a Moving Picture Experts Group Audio Layer 4 (MP4) video player, a video camera, a game console, etc. In addition, with the continuous progress of technologies, display panels are also beginning to be applied to some emerging fields, such as smart watches, vehicle-mounted displays (such as an odometer display and a rear-view camera display), electronic photographs, electronic billboards or signboards, projectors, etc.

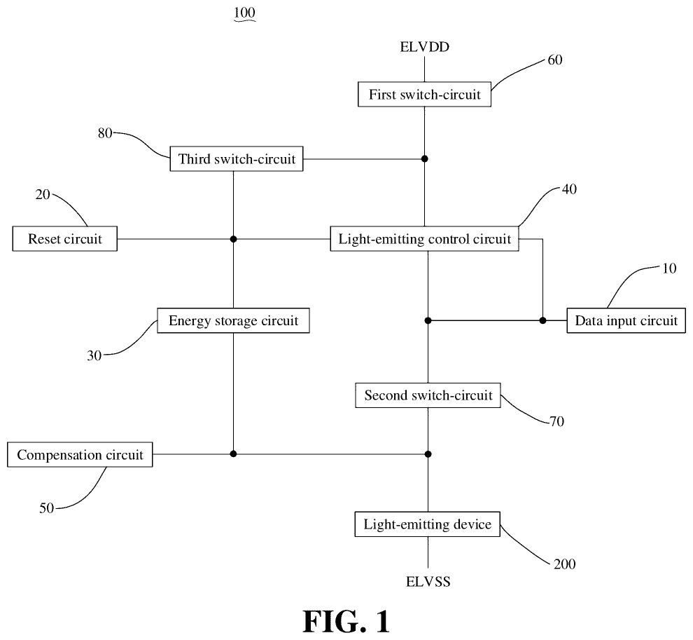

Reference can be made to FIG. 1, which is a schematic block diagram of a pixel driving circuit 100 provided in an implementation of the present disclosure. The pixel driving circuit 100 includes a data input circuit 10, a reset circuit 20, an energy storage circuit 30, a light-emitting control circuit 40, a compensation circuit 50, a first switch-circuit 60, a second switch-circuit 70, and a third switch-circuit 80. The data input circuit 10 is electrically connected to a first end and a first control end of the light-emitting control circuit 40. An output end of the reset circuit 20 is electrically connected to a second control end of the light-emitting control circuit 40. A second end of the light-emitting control circuit 40 is connected to a first voltage ELVDD through a first switch-circuit 60. The first end of the light-emitting control circuit 40 is electrically connected to an anode of the light-emitting device 200 through the second switch-circuit 70, and the other end of the light-emitting device 200 is connected to a second voltage ELVSS. An output end of the compensation circuit 50 is electrically connected to the anode of the light-emitting device 200. One end of the energy storage circuit 30 is electrically connected to an output end of the reset circuit 20, and the other end of the energy storage circuit 30 is electrically connected to the output end of the compensation circuit 50. One end of the third switch-circuit 80 is electrically connected to the output end of the reset circuit 20, and the other end of the third switch-circuit 80 is electrically connected to the second end of the light-emitting control circuit 40. The compensation circuit 50 and the third switch-circuit 80 are configured to be turned on according to a first scanning signal S(n) in a data-writing phase. The first switch-circuit 60 and the second switch-circuit 70 are configured to be turned on according to an enable signal Emit in a light-emitting phase.

A second scanning signal S(n−1) controls on/off of the reset circuit 20. The reset circuit 20 can output a reference voltage Vref to the second control end of the light-emitting control circuit 40 on condition that the reset circuit 20 is turned on, thereby resetting the light-emitting control circuit 40. The first scanning signal S(n) controls on/off of each of the data input circuit 10, the compensation circuit 50, the light-emitting control circuit 40, and the third switch-circuit 80. On condition that each of the data input circuit 10, the compensation circuit 50, the light-emitting control circuit 40, and the third switch-circuit 80 is turned on, data signal Data is used for writing a data voltage Vdata into the energy storage circuit 30. The enable signal controls on/off of each of the first switch-circuit 60 and the second switch-circuit 70. On condition that each of the first switch-circuit 60 and the second switch-circuit 70 is turned on, the energy storage circuit 30 can output the data voltage written in the previous phase to the second control end of the light-emitting control circuit, so that the light-emitting device 200 emits light. Thus, the second scanning signal S(n−1), the first scanning signal S(n), and the enable signal are combined and corresponds to the reset phase, the data-writing phase, and the light-emitting phase in sequence. The number of driving lines is reduced, which facilitates reducing the width of the frame.

Specifically, in the data-writing phase, under the control of the first scanning signal S(n), the third switch-circuit 80 connects the energy storage circuit 30 to the second end of the light-emitting control circuit 40. Under the control of the first scanning signal S(n), the data input circuit 10 transmits the data signal Data to the first control end of the light-emitting control circuit 40, a corresponding data voltage Vdata is written into the energy storage circuit 30, and the energy storage circuit 30 stores the data voltage Vdata provided by the data signal Data to subsequently control the brightness of the light-emitting device 200. Under the control of the first scanning signal S(n), the compensation circuit 50 operates in cooperation with the third switch-circuit 80, and performs threshold voltage compensation or other necessary compensation on the light-emitting control circuit 40, so as to improve the uniformity and accuracy of display.

In the light-emitting phase, under the control of the enable signal Emit, the first switch-circuit 60 and the second switch-circuit 70 respectively enable the first voltage ELVDD and the voltage of the energy storage circuit 30 to be transmitted to the light-emitting control circuit 40 and the light-emitting device 200, so that an accurate driving current is output to the light-emitting device 200, thereby driving the light-emitting device 200 to emit light.

In the reset phase, under the control of the second scanning signal S(n−1), the reset circuit 20 outputs the reference voltage Vref to the second control end of the light-emitting control circuit 40, to initialize the light-emitting control circuit 40, so that it is ensured that the light-emitting control circuit 40 is in a known state at the beginning of each display period.

The first scanning signal S(n) is output by a first scanning line, and the second scanning signal S(n−1) is output by a second scanning line. In the pixel driving circuit 100, the first scanning line and the second scanning line are scanning signal lines which are parallel to each other and transmit signals independently from each other, so as to ensure that each pixel unit can receive a correct control signal according to a predetermined timing. In this embodiment, the first scanning line and the second scanning line may also be shared. The first scanning signal S(n) is a scanning signal at a present phase, and the second scanning signal S(n−1) is a scanning signal at a previous phase. Therefore, the number of row scanning signal lines required in the present disclosure is relatively small, thereby further preventing leakage of electricity and thus the circuit failure, and improving the overall stability of the pixel driving circuit 100 of the display panel. Meanwhile, the number of GateDriver On Array (GOA) lines is further reduced, and the circuit complexity is reduced, so that the width of the product bezel is narrowed, and narrow bezel products can be realized.

It can be understood that, the first scanning signal S(n), the second scanning signal S(n−1), and the enable signal Emit may be generated and output by a timing signal generation module in the display device (i.e., internally generated), or may be signals externally transmitted to the display panel. Similarly, a first voltage ELVDD signal and a second voltage ELVSS signal may be generated and output by a power-supply module in the display device, or may be signals transmitted from an external power supply to the display panel, which is not limited in the present disclosure.

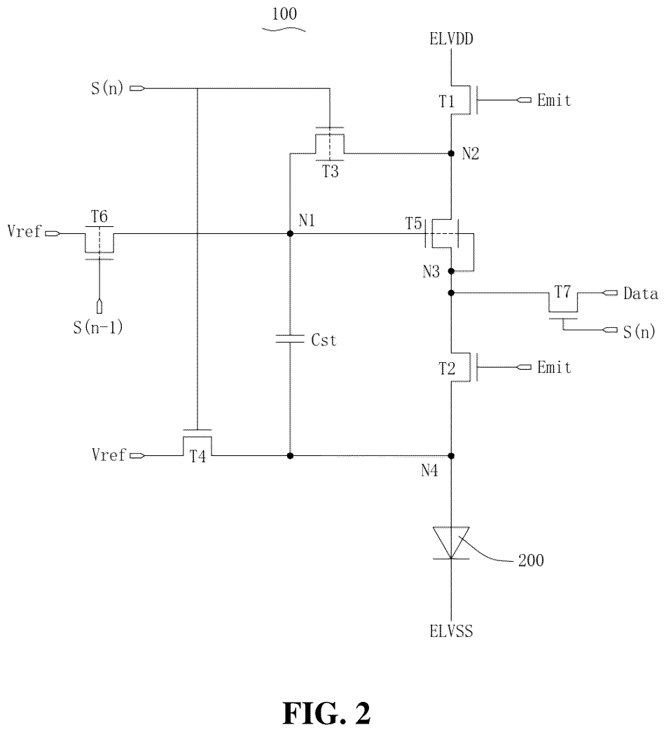

Specifically, reference can be made to FIG. 2, which is a circuit diagram of a pixel driving circuit 100. The specific circuit structure of the present disclosure will be described below.

The reset circuit 20 includes a reset transistor T6. The reset transistor T6 is configured to receive the second scanning signal S(n−1) through a gate of the reset transistor T6. The reset transistor T6 is directly controlled by the second scanning signal S(n−1) to be turned on or turned off. In the reset phase, when the second scanning signal S(n−1) is at a high potential, the reset transistor T6 is turned on. In other phases, the reset transistor T6 is turned off. The reset transistor T6 is configured to receive the reference voltage Vref through a second electrode of the reset transistor T6. The reference voltage Vref is a known and stable voltage and is used for initializing the second control end (usually a voltage at a certain node) of the light-emitting control circuit 40 to a definite state in the reset phase. A first electrode of the reset transistor T6 is electrically connected to a first node N1. The first node N1 is a key node in the circuit. The voltage state of the first node N1 directly influences the operating state of the light-emitting control circuit 40. In the reset phase, when the reset transistor T6 is turned on, the reference voltage Vref is applied to the first node N1 through the reset transistor T6, to reset the light-emitting control circuit 40.

In the reset phase, the reset transistor T6 is controlled to be turned on by the second scanning signal S(n−1), to apply the reference voltage Vref to the first node N1, so that the light-emitting control circuit 40 is reset. This process is curial to eliminate an influence left by a previous display period, and is curial to ensure that the circuit is in a known state at the beginning of each display period. Meanwhile, the reset phase also provides a stable initial condition for the subsequent data writing phase and light-emitting phase, thereby helping to improve the compensation capability and display quality of the circuit.

Compared with the present pixel compensation circuit (6T1C), the pixel driving circuit 100 in the present disclosure is additionally provided with the reset transistor T6. In the reset phase, the first control end of the light-emitting control circuit 40 is reset under the control of the second scanning signal S(n−1). The introduction of the reset transistor T6 enhances the control capability of the pixel driving circuit 100 in the reset phase, thereby helping to improve the compensation capability and the overall performance of the pixel driving circuit 100.

The light-emitting control circuit 40 includes a driving transistor T5. The driving transistor T5 is a four-terminal driving device having a first control end and a second control end. The second control end of the driving transistor T5 is connected to the first node N1. A first electrode of the driving transistor T5 is connected to a second node N2. The second control end and a second electrode of the driving transistor T5 are connected to a third node N3. The driving transistor T5, as a main component of the light-emitting control circuit 40, precisely controls the brightness of the light-emitting element by the four-terminal configuration of the driving transistor T5. The voltage regulation of the first node N1, the supply of the stable power supply of the second node N2, and the feedback of the voltage at the third node N3 together form the basis for the operation of the driving transistor T5, thereby ensuring that the pixel driving circuit 100 can drive the light-emitting element to display according to predetermined timing and brightness requirements.

The data input circuit 10 includes a writing transistor T7. The writing transistor T7 is configured to receive a data signal Data through a first electrode of the writing transistor T7. A second electrode of the writing transistor T7 is connected to the third node N3. The writing transistor T7 is configured to receive a first scanning signal S(n) through a gate of the writing transistor T7. That is, the data signal Data output by the data input circuit 10 can control the driving transistor T5 to be turned on, so that the data signal Data can be written into the energy storage circuit 30. The data input circuit 10 is configured to transmit an external data signal Data, through the writing transistor T7, to the interior of the circuit at an appropriate opportunity, in particular to the key node related to the driving transistor T5 and the energy storage circuit 30. This design ensures that the pixel driving circuit 100 can precisely control the brightness of the light-emitting element according to the externally input data signal, thereby realizing a high-quality display effect.

The third switch-circuit 80 includes a third transistor T3. A first electrode of the third transistor T3 is electrically connected to an input end of the light-emitting control circuit 40. A second electrode of the third transistor T3 is electrically connected to an output end of the reset circuit 20. The third transistor T3 is configured to receive the first scanning signal S(n) through a gate of the third transistor T3. The third switch-circuit 80 can switch the signal at the input end of the light-emitting control circuit 40 by the on/off of the third transistor T3. In the reset phase, when the third transistor T3 is turned on, an output signal from the reset circuit 20 can be transmitted to the input end of the light-emitting control circuit 40, so as to reset the light-emitting control circuit 40. In other phases, when the third transistor T3 is turned off, the light-emitting control circuit 40 receives signals from other circuits (such as the data input circuit 10) through the input end of the light-emitting control circuit 40. By introducing the third switch-circuit 80, the pixel driving circuit 100 can precisely control the input end of the light-emitting control circuit 40 in different operating phases. It is helpful to eliminate the influence left by the previous display period and ensure that the circuit is in a known state at the beginning of each display period, thereby enhancing the stability and reliability of the circuit.

The compensation circuit 50 includes a fourth transistor T4. The fourth transistor T4 is configured to receive a first scanning signal S(n) through a gate of the fourth transistor T4. The fourth transistor T4 is configured to receive a reference voltage Vref through a first electrode of the fourth transistor T4. A second electrode of the fourth transistor T4 is electrically connected to a fourth node N4. The fourth transistor T4, as a main component of the compensation circuit 50, realizes the function of introducing the reference voltage Vref into the circuit at a specific timing by controlling the on/off of the fourth transistor T4. This design not only simplifies the circuit structure, but also improves the compensation capability and overall performance of the circuit, thereby providing powerful support for high-performance display of the pixel driving circuit 100.

The energy storage circuit 30 includes a storage capacitor Cst. The storage capacitor Cst is connected between the first node N1 and the fourth node N4. The storage capacitor Cst in the energy storage circuit 30 realizes charge storage by connecting the first node N1 and the fourth node N4. In addition, in the light-emitting phase, the brightness of the light-emitting element is precisely controlled by the voltage difference and the amount of charges across the storage capacitor Cst, thereby realizing a high-quality display effect.

The writing transistor T7, the third transistor T3, and the fourth transistor T4 are configured to receive the same scanning signal, that is, the writing transistor T7, the third transistor T3, and the fourth transistor T4 are turned on at the same time, so that the data signal Data can be written into the storage capacitor Cst.

The third transistor T3 is an Indium Gallium Zinc Oxide (IGZO) transistor, which can significantly increase the charging and discharging rate for the pixel electrode, thereby reducing the leakage current of the node.

The first switch-circuit 60 includes a first transistor T1. The second switch-circuit 70 includes a second transistor T2. The first transistor T1 is configured to receive an enable signal Emit through a gate of the first transistor T1, and the second transistor T2 is configured to receive the enable signal Emit through a gate of the second transistor T2. Compared with the traditional pixel compensation circuit 50 (6T1C), the gate of the first transistor T1 and the gate of the second transistor T2 in the present disclosure receive the same enable signal Emit, so that fewer signal lines can be used.

In conclusion, the pixel driving circuit 100 includes the driving transistor T5, the reset transistor T6, the writing transistor T7, the first transistor T1, the second transistor T2, the third transistor T3, the fourth transistor T4, and the storage capacitor Cst. By means of the first scanning signal S(n), the second scanning signal S(n−1), and the enable signal Emit, the on/off states of various transistors are respectively controlled at different moments, and the voltage of the anode of the light-emitting device 200 is initialized and compensated, so that a certain voltage difference is formed between the anode of the light-emitting device 200 and the cathode of the light-emitting device 200, and thus the current flowing through the light-emitting device 200 is not affected by the threshold voltage of the driving transistor T5.

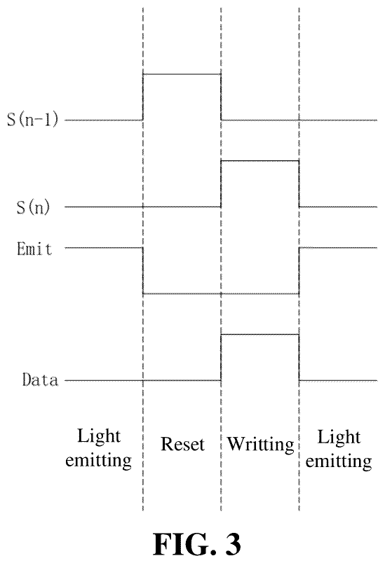

In this embodiment, the second scanning signal S(n−1), the first scanning signal S(n), and the enabling signal Emit are combined and corresponds to the reset phase, the data-writing phase, and the light-emitting phase in sequence. Referring to FIG. 2 and FIG. 3, the potential change in each of the reset phase, the data-writing phase, and the light-emitting phase, and how to realize the compensation for the threshold voltage of the driving transistor T5 are analyzed in detail below.

In the reset phase, the first scanning signal S(n) is at a low potential, the second scanning signal S(n−1) is at a high potential, the enable signal Emit is at a low potential, and the data signal Data is at a low potential.

In this phase, the second scanning signal S(n−1) received by the gate of the reset transistor T6 is at a high potential, and at this time, the reset transistor T6 is in an on state. The first scanning signal S(n) received by each of the gate of the third transistor T3, the gate of the fourth transistor T4, and the gate of the writing transistor T7 is at a low potential, and at this time, the third transistor T3, the fourth transistor T4, and the writing transistor T7 are in an off state. The enable signal Emit received by each of the gate of the first transistor T1 and the gate of the second transistor T2 is at a low potential, and at this time, the first transistor T1 and the second transistor T2 are in an off state.

Therefore, at this time, the reference voltage Vref is written into the first node N1, and the light-emitting device 200 does not emit light.

In the data-writing phase, the first scanning signal S(n) is at a high potential, the second scanning signal S(n−1) is at a low potential, the enabling signal Emit is at a low potential, and the data signal Data is at a high potential.

The second scanning signal S(n−1) received by the gate of the reset transistor T6 is at a low potential, and at this time, the reset transistor T6 is in an off state. The first scanning signal S(n) received by each of the gate of the third transistor T3, the gate of the fourth transistor T4, and the gate of the writing transistor T7 is at a high potential, and at this time, the third transistor T3, the fourth transistor T4, and the writing transistor T7 are in an on state. The enable signal Emit received by each of the gate of the first transistor T1 and the gate of the second transistor T2 is at the low potential, and at this time, the first transistor T1 and the second transistor T2 are in an off state.

Therefore, at this time, the data voltage Vdata is written into the third node N3, and the driving transistor T5 is turned on. At this time, the data signal Data is continuously written into the first node N1 and the second node N2 until the voltage at the first node N1 and the voltage at the second node N2 satisfy the cut-off condition of the driving transistor T5, and the writing of the data signal Data is completed. At this time, VN1=VN2=Vdata+Vth, which is stored through the storage capacitor Cst. The reference voltage Vref is written into the fourth node N4. At this time, the voltage at the first node N1 and the voltage at the second node N2 contain the information about the threshold voltage Vth of the driving transistor T5. Since the first transistor T1 and the second transistor T2 are still in an off state, the light-emitting device 200 does not emit light.

In the light-emitting phase, the first scanning signal S(n) is at a low potential, the second scanning signal S(n−1) is at a low potential, the enable signal Emit is at a high potential, and the data signal Data is at a low potential.

The second scanning signal S(n−1) received by the gate of the reset transistor T6 is at a low potential, and at this time, the reset transistor T6 is in an off state. The first scanning signal S(n) received by each of the gate of the third transistor T3, the gate of the fourth transistor T4, and the gate of the writing transistor T7 is at a low potential, and at this time, the third transistor T3, the fourth transistor T4, and the writing transistor T7 are in an off state. The enable signal Emit received by each of the gate of the first transistor T1 and the gate of the second transistor T2 is at a high potential, and at this time, the first transistor T1 and the second transistor T2 are in an on state.

Therefore, at this time, since the voltage information Vdata+Vth of the previous phase is stored at the first node N1, the driving transistor T5 is turned on. At this time, the first voltage ELVDD is input to the driving transistor T5, and the ELVDD is relatively controlled by the gate voltage of the driving transistor T5 (the Vdata signal input that has been input at the first node N1). At this time, the voltage at the second node N2 is N2=Vdata, the voltage at the first node N1 is N1=Vdata+Vth+ELVSS+Voled-Vref, and the voltage at the fourth node N4 is N4−ELVSS+Voled. The light-emitting device 200 emits light. The current value through the light-emitting device 200 is a function of the gate-source voltage and the cut-off voltage Vth, so that the voltage at the first node N1 can be seen as Vth+Vdata according to the previous step. Thus, the current IDS of the driving transistor T5, that is, the leakage current, is a function of a gate-source voltage difference (Vth+Vdata−Vdd) and the cut-off voltage Vth, and has no nothing to do with the threshold voltage Vth of the driving transistor T5. Therefore, the threshold voltage Vth of the driving transistor T5 can be compensated, and the uniformity of the light emission of the OLED pixel can be improved.

Thus, a refresh period of OLED is completed. Then, the procedure returns to the first phase to reset the voltage across the storage capacitor Cst and prepare for the next round of signal input.

In the pixel driving circuit 100 provided in the above embodiments, each transistor may be a Thin Film Transistor (TFT), a Field Effect Transistor (FET), or any other switch device with the same characteristics, which are not limited by the embodiments of the present disclosure.

Exemplarily, on condition that the transistor is a P-type transistor, such as a Positive channel Matel Oxide Semiconductor Field Effect Transistor (PMOSFET), a first electrode of the transistor is a source, and a second electrode of the transistor is a drain. Exemplarily, on condition that the transistor is an N-type transistor, such as a Negative channel Metal Oxide Semiconductor Field Effect Transistor (NMOSFET), a first electrode of the transistor is a drain, and a second electrode of the transistor is a source.

In the description of embodiments of the present disclosure, it may be noted that orientation or positional relations indicated by terms such as “center”, “on”, “under”, “left”, “right”, “vertical”, “horizontal”, “in”, “out”, and the like are orientation or positional relations based on the accompanying drawings, only for facilitating description of the present disclosure and simplifying the description, rather than explicitly or implicitly indicating the referred devices or elements must be in a particular orientation or constructed or operated in the particular orientation, and therefore they may not be construed as limiting the present disclosure.

The above embodiments are only one of preferable embodiments of the present disclosure, and cannot be used to limit the scope of the claims of the present disclosure. Those of ordinary skill in the art can understand all or a part of the process to realize the above embodiments of the present disclosure, and the equivalent changes made in accordance with the claims of the present disclosure still belong to the scope of the present disclosure.

What is claimed is:

1. A pixel driving circuit, comprising a data input circuit, a reset circuit, an energy storage circuit, a light-emitting control circuit, a compensation circuit, a first switch-circuit, a second switch-circuit, and a third switch-circuit; wherein
the data input circuit is electrically connected to a first end of the light-emitting control circuit and a first control end of the light-emitting control circuit, and is configured to output a data signal to the first control end of the light-emitting control circuit according to a first scanning signal in a data-writing phase;
an output end of the reset circuit is electrically connected to a second control end of the light-emitting control circuit, and the reset circuit is configured to output a reference voltage to the second control end of the light-emitting control circuit according to a second scanning signal in a reset phase;
a second end of the light-emitting control circuit is electrically connected to the first switch-circuit, the first end of the light-emitting control circuit is configured to be electrically connected to an anode of a light-emitting device through the second switch-circuit, and the light-emitting control circuit is configured to output a driving current to the light-emitting device in a light-emitting phase;
an output end of the compensation circuit is configured to be electrically connected to the anode of the light-emitting device;
one end of the energy storage circuit is electrically connected to the output end of the reset circuit, and the other end of the energy storage circuit is electrically connected to the output end of the compensation circuit;
one end of the third switch-circuit is electrically connected to the output end of the reset circuit, and the other end of the third switch-circuit is electrically connected to the second end of the light-emitting control circuit; and
wherein the compensation circuit and the third switch-circuit are configured to be turned on according to the first scanning signal in the data-writing phase; and the first switch-circuit and the second switch-circuit are configured to be turned on according to an enable signal in the light-emitting phase.

2. The pixel driving circuit of claim 1, wherein the reset circuit comprises a reset transistor, a first electrode of the reset transistor is electrically connected to the second control end of the light-emitting control circuit, the reset transistor is configured to receive a reference voltage through a second electrode of the reset transistor, and the reset transistor is configured to receive the second scanning signal through a gate of the reset transistor.

3. The pixel driving circuit of claim 1, wherein the first scanning signal is a scanning signal at a present phase, and the second scanning signal is a scanning signal at a previous phase.

4. The pixel driving circuit of claim 1, wherein in the reset phase, the first scanning signal is at a low potential, the second scanning signal is at a high potential, the enable signal is at a low potential, and the data signal is at a low potential.

5. The pixel driving circuit of claim 1, wherein in the data-writing phase, the first scanning signal is at a high potential, the second scanning signal is at a low potential, the enable signal is at a low potential, and the data signal is at a high potential.

6. The pixel driving circuit of claim 1, wherein in the light-emitting phase, the first scanning signal is at a low potential, the second scanning signal is at a low potential, the enable signal is at a high potential, and the data signal is at a low potential.

7. The pixel driving circuit of claim 1, wherein the data input circuit comprises a writing transistor, the writing transistor is configured to receive the data signal through a first electrode of the writing transistor, a second electrode of the writing transistor is electrically connected to an output end of the light-emitting control circuit and the first control end of the light-emitting control circuit, and the writing transistor is configured to receive the first scanning signal through a gate of the writing transistor.

8. The pixel driving circuit of claim 1, wherein the first switch-circuit comprises a first transistor, the second switch-circuit comprises a second transistor, the first transistor is configured to receive the enable signal through a gate of the first transistor, and the second transistor is configured to receive the enable signal through a gate of the second transistor.

9. The pixel driving circuit of claim 1, wherein the third switch-circuit comprises a third transistor, a first electrode of the third transistor is electrically connected to an input end of the light-emitting control circuit, a second electrode of the third transistor is electrically connected to the output end of the reset circuit, and the third transistor is configured to receive the first scanning signal through a gate of the third transistor; and the third transistor is an Indium Gallium Zinc Oxide (IGZO) transistor.

10. The pixel driving circuit of claim 1, wherein the compensation circuit comprises a fourth transistor, the fourth transistor is configured to receive the first scanning signal through a gate of the fourth transistor, the fourth transistor is configured to receive the reference voltage through a first electrode of the fourth transistor, and a second electrode of the fourth transistor is configured to be electrically connected to the anode of the light-emitting device.

11. A display device, comprising a plurality of light-emitting devices distributed in an array and a pixel driving circuit, wherein the pixel driving circuit is configured to drive the plurality of light-emitting devices to operate, and the pixel driving circuit comprises a data input circuit, a reset circuit, an energy storage circuit, a light-emitting control circuit, a compensation circuit, a first switch-circuit, a second switch-circuit, and a third switch-circuit; wherein
the data input circuit is electrically connected to a first end of the light-emitting control circuit and a first control end of the light-emitting control circuit, and is configured to output a data signal to the first control end of the light-emitting control circuit according to a first scanning signal in a data-writing phase;
an output end of the reset circuit is electrically connected to a second control end of the light-emitting control circuit, and the reset circuit is configured to output a reference voltage to the second control end of the light-emitting control circuit according to a second scanning signal in a reset phase;
a second end of the light-emitting control circuit is electrically connected to the first switch-circuit, the first end of the light-emitting control circuit is electrically connected to an anode of each of the plurality of light-emitting devices through the second switch-circuit, and the light-emitting control circuit is configured to output a driving current to each of the plurality of light-emitting devices in a light-emitting phase;
an output end of the compensation circuit is electrically connected to the anode of each of the plurality of light-emitting devices;
one end of the energy storage circuit is electrically connected to the output end of the reset circuit, and the other end of the energy storage circuit is electrically connected to the output end of the compensation circuit;
one end of the third switch-circuit is electrically connected to the output end of the reset circuit, and the other end of the third switch-circuit is electrically connected to the second end of the light-emitting control circuit; and
wherein the compensation circuit and the third switch-circuit are configured to be turned on according to the first scanning signal in the data-writing phase; and the first switch-circuit and the second switch-circuit are configured to be turned on according to an enable signal in the light-emitting phase.

12. The display device of claim 11, wherein the reset circuit comprises a reset transistor, a first electrode of the reset transistor is electrically connected to the second control end of the light-emitting control circuit, the reset transistor is configured to receive a reference voltage through a second electrode of the reset transistor, and the reset transistor is configured to receive the second scanning signal through a gate of the reset transistor.

13. The display device of claim 11, wherein the first scanning signal is a scanning signal at a present phase, and the second scanning signal is a scanning signal at a previous phase.

14. The display device of claim 11, wherein in the reset phase, the first scanning signal is at a low potential, the second scanning signal is at a high potential, the enable signal is at a low potential, and the data signal is at a low potential.

15. The display device of claim 11, wherein in the data-writing phase, the first scanning signal is at a high potential, the second scanning signal is at a low potential, the enable signal is at a low potential, and the data signal is at a high potential.

16. The display device of claim 11, wherein in the light-emitting phase, the first scanning signal is at a low potential, the second scanning signal is at a low potential, the enable signal is at a high potential, and the data signal is at a low potential.

17. The display device of claim 11, wherein the data input circuit comprises a writing transistor, the writing transistor is configured to receive the data signal through a first electrode of the writing transistor, a second electrode of the writing transistor is electrically connected to an output end of the light-emitting control circuit and the first control end of the light-emitting control circuit, and the writing transistor is configured to receive the first scanning signal through a gate of the writing transistor.

18. The display device of claim 11, wherein the first switch-circuit comprises a first transistor, the second switch-circuit comprises a second transistor, the first transistor is configured to receive the enable signal through a gate of the first transistor, and the second transistor is configured to receive the enable signal through a gate of the second transistor.

19. The display device of claim 11, wherein the third switch-circuit comprises a third transistor, a first electrode of the third transistor is electrically connected to an input end of the light-emitting control circuit, a second electrode of the third transistor is electrically connected to the output end of the reset circuit, and the third transistor is configured to receive the first scanning signal through a gate of the third transistor; and the third transistor is an Indium Gallium Zinc Oxide (IGZO) transistor.

20. The display device of claim 11, wherein the compensation circuit comprises a fourth transistor, the fourth transistor is configured to receive the first scanning signal through a gate of the fourth transistor, the fourth transistor is configured to receive the reference voltage through a first electrode of the fourth transistor, and a second electrode of the fourth transistor is electrically connected to the anode of each of the plurality of light-emitting devices.
